(19) United States
(12) Patent Application Publication
(10) Pub. No.: US 2006/0242258 A1
(43) Pub. Date: Oct. 26, 2006

(54) File sharing system, file sharing program, management server and client terminal

(75) Inventor: Atsuhisa Ohtani, Tokyo (JP)

Correspondence Address: SUGHRUE MION, PLLC, 2100 PENNSYLVANIA AVENUE, N.W., SUITE 800, WASHINGTON, DC, 20037, US

(73) Assignee: NEC CORPORATION

(21) Appl. No.: 11/407,983

(22) Filed: Apr. 21, 2006

(30) Foreign Application Priority Data
Apr. 22, 2005 (JP) 2005-124573

(51) Int. Cl. G06F 15/167

(52) U.S. Cl. 709/216

(57) ABSTRACT

A file sharing system comprises a client for transmitting only control information on I/O to a server and, based on I/O target determination information received from the server, performing I/O by itself with a disk device, a server for receiving control information from the client and transmitting to the client information for determining the disk device targeted for the I/O or information for notifying the performance of I/O termination processing, and a disk device connected to the client and the server through a network line, comprising a protocol conversion means for taking out a command based on an I/O protocol such as SCSI from the I/O information converted into a format suitable for the I/O protocol and received from the client.

### BACKGROUND OF THE INVENTION

1. Field of the Invention

The present invention relates to file sharing, and, more particularly, to a file sharing system having at least one disk device disposed accessibly through a network, a file sharing program, a management server and a client terminal.

2. Description of the Related Art

FIG. 14 is a schematic diagram illustrating an example of a conventional file sharing system.

In file sharing using a conventional network file system shown in FIG. 14, network protocols, such as TCP/IP, are used to send and receive In/Out (I/O) data between a client and a server and achieve file sharing.

A conventional file sharing method having such a configuration operates as follows:

Each of the server and the client has a communication control means; when writing data to a disk device, the server receives from the client each of the I/O data divided into small size chunks, issues through a file system management means the I/O to the disk device, and transmits by a communication control means through an I/O control means and the files system management means an I/O termination notification to the client.

However, problems exist in the above conventional file sharing system, as described below.

A first problem is the large amount of consumption of server memory and CPU resources.

The reason is, since the I/O data is sent/received between the client and the disk device through the server, a region must be reserved for temporarily keeping the I/O data in the memory of the server; also, considerable CPU resources are consumed to process the I/O data itself. It follows that, since, in an environment where multiple clients are connected to a server, the processing burden on the server and the load on the network are increased, the system configuration is not desirable.

A second problem is that the data size of the I/O issued by the server to the disk device becomes small, leading to poor I/O efficiency.

The reason is that, since conditions required by a communication protocol has to be met in order to forward the I/O data through the network, the I/O data forwarded through the network must be divided to obtain smaller data sizes.

A third problem is that the disk device must be disposed at a position that is physically close to the server.

The reason is the necessity to connect the disk device to the server by an I/O type protocol such as Fibre Channel in order to forward the I/O data.

The above problems similarly apply to network attached storage (commonly referred to as NAS).

Meanwhile, another example of the conventional file sharing system is described in Document 1 (Japanese Patent Laid-open No. 2000-250821).

This system shares storage devices through a switch as shown in FIG. 15, and achieves acceleration of data transfers by directly forwarding data to peripheral devices using a third-party transfer (TPT) I/O management means, thereby resolving the above problems.

A conventional file sharing method having such a configuration example operates as follows:

Each of the server and the client has a communication control means; the communication control means of the server provides a file system management means with an I/O request information that has been transmitted by the communication control means of the client, and additionally provides an I/O control means with information such as offset within the file and I/O size for the I/O request information.

Then, the actual I/O is performed between the peripheral device and the client.

Thereafter, the communication control means transmits an I/O termination notification to the client through the I/O control means and the file system management means of the server.

In this way, in the case of a conventional file sharing system that is based on a network and a storage area network as shown in FIG. 15, since a network using a communication line such as Ethernet (R) is not used for data transfers between the disk device and a host computer, there is an effect of reducing the network load.

However, challenges exist in the above conventional file sharing system including the above-mentioned Document 1, as described below.

A first challenge is that each of a network such as Ethernet (R) and a storage area network based on Fibre Channel or the like must be constructed independently, thus requiring high cost of construction.

A second challenge is that each of a network such as Ethernet (R) and a storage area network based on Fibre Channel or the like must be constructed independently, thus requiring high skills for system management.

A third challenge is that, a wide area network such as Ethernet (R) cannot be constructed using Fibre Channel for file sharing among computers distributed over a wide area such as grid computing, thus it is practically impossible to use an I/O type protocol such as Fibre Channel for connection.

In addition, hereafter, “network” refers to a network using Ethernet (R) or the like, while “Storage Area Network (SAN)” refers to a storage area network using Fibre Channel or the like.

### SUMMARY OF THE INVENTION

An object of the present invention is to provide a file sharing system, a file sharing program, a management server and a client terminal facilitating system construction with a wide area network and management thereof, and allowing the costs of system construction and operation management to be reduced.

According to one aspect of the invention, a file sharing system whereby a plurality of client terminals shares data stored in at least one disk device through a networked management server, wherein the disk device is disposed to be accessible by the client terminal through the network, and the management server, based on the data input/output request from the client terminal, transmits to the client terminal, determination information comprising positional information on the disk device targeted for input/output request and the area targeted for the input/output request on the disk device.

In the preferred construction, the client terminal, based on the determination information that was transmitted by the management server, directly accesses the area or the data on the disk device through a network.

In the present invention, the client terminal receives determination information containing positional information on the disk device where the data requested for I/O is present and the data from the management server, and recognizes the position of the data on the disk device in the network.

The client terminal directly accesses the data on the disk device, and directly reaches the data requested for I/O through a network.

According to the present invention, the effect of allowing file sharing among computers distributed over a wide area on a network to be achieved with reduction in cost is realized.

The reason is, since a management server transmits to the client terminal determination information including positional information on a disk device targeted for I/O request, which is disposed to be accessible by the client terminal through the network, and an area targeted for the I/O request on the disk device, based on the I/O request of the data from the client terminal, and the client terminal recognizes and directly accesses the position of the data on the disk device on the network, the need for constructing a wide area network such as Ethernet (R) using Fibre Channel is eliminated, and the need for constructing independently each of a network in Ethernet (R) or the like and a storage area network based on Fibre Channel or the like is eliminated, thus facilitating the system construction and the management thereof with a network, therefore, high skills are not required for system management, and the costs of system construction and operation management are reduced.

Other objects, features and advantages of the present invention will become clear from the detailed description given herebelow.

### BRIEF DESCRIPTION OF THE DRAWINGS

The present invention will be understood more fully from the detailed description given herebelow and from the accompanying drawings of the preferred embodiment of the invention, which, however, should not be taken to be limitative to the invention, but are for explanation and understanding only.

In the drawings:

FIG. 1 is a block diagram illustrating a configuration of a configuration unit example of a file sharing system according to an embodiment of the present invention;

FIG. 2 is a diagram generally illustrating the configuration of the file sharing system according to the embodiment of the present invention;

FIG. 3 is a block diagram illustrating an example of the configuration of the file sharing system according to the embodiment of the present invention;

FIG. 4 is a block diagram illustrating another example of the configuration of the file sharing system according to the embodiment of the present invention;

FIG. 5 is a diagram illustrating correspondences comprised in a server of the file sharing system according to the embodiment of the present invention;

FIG. 6 is a flow chart illustrating an operation of the I/O request process 11 of the file sharing system according to the embodiment of the embodiment of the present invention;

FIG. 7 is a flow chart illustrating an operation of the transmission process 13 of the file sharing system according to the embodiment of the embodiment of the present invention;

FIG. 8 is a flow chart illustrating an operation of the reception process 14 of the file sharing system according to the embodiment of the embodiment of the present invention;

FIG. 9 is a flow chart illustrating an operation of the interrupt processing 16 of the file sharing system according to the embodiment of the present invention;

FIG. 10 is a flow chart illustrating an operation of the reception process 21 of the file sharing system according to the present embodiment;

FIG. 11 is a flow chart illustrating an operation of the I/O process 24 of the file sharing system according to the present embodiment;

FIG. 12 is a flow chart illustrating an operation of the transmission process 26 of the file sharing system according to the present embodiment;

FIG. 13 is a block diagram illustrating the hardware configuration of a computer processor 400 on the file sharing system according to the embodiment of the present invention;

FIG. 14 is a diagram generally illustrating an example of the configuration of a conventional file sharing system; and

FIG. 15 is a diagram generally illustrating an example of the configuration of a conventional file sharing system.

### DESCRIPTION OF THE PREFERRED EMBODIMENT

The preferred embodiment of the present invention will be discussed hereinafter in detail with reference to the accompanying drawings. In the following description, numerous specific details are set forth in order to provide a thorough understanding of the present invention. It will be obvious, however, to those skilled in the art that the present invention may be practiced without these specific details. In other instance, well-known structures are not shown in detail in order to unnecessary obscure the present invention.

(Configuration of File Sharing System)

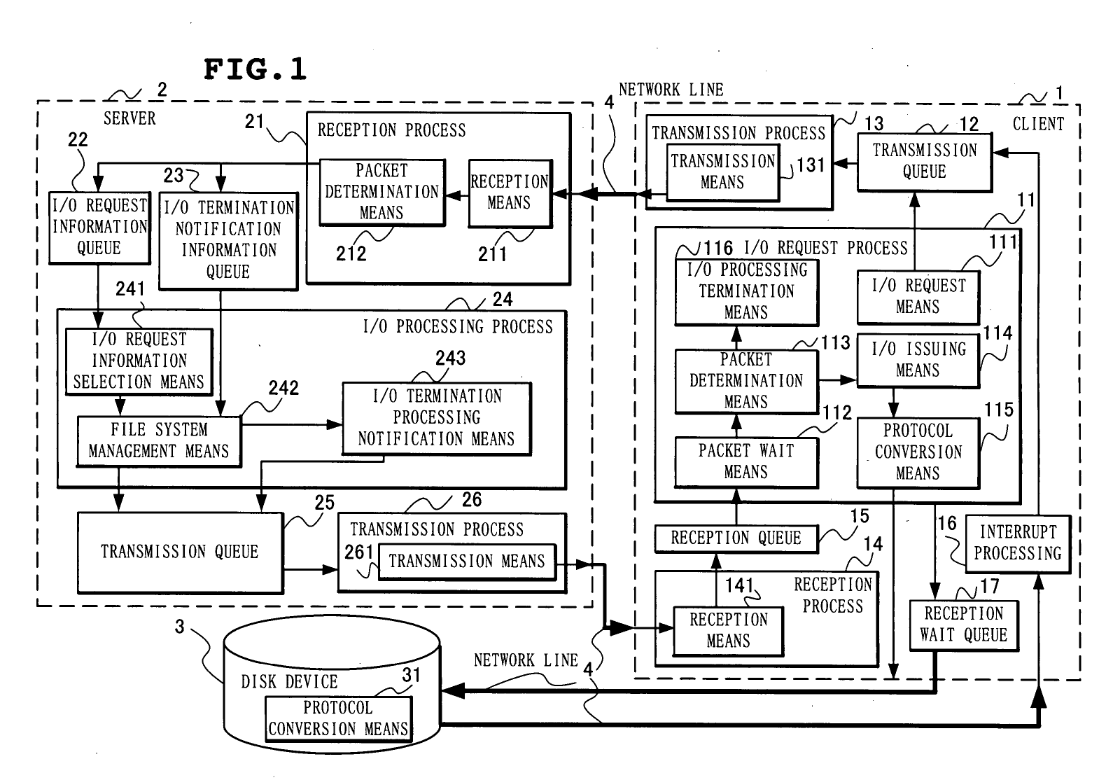

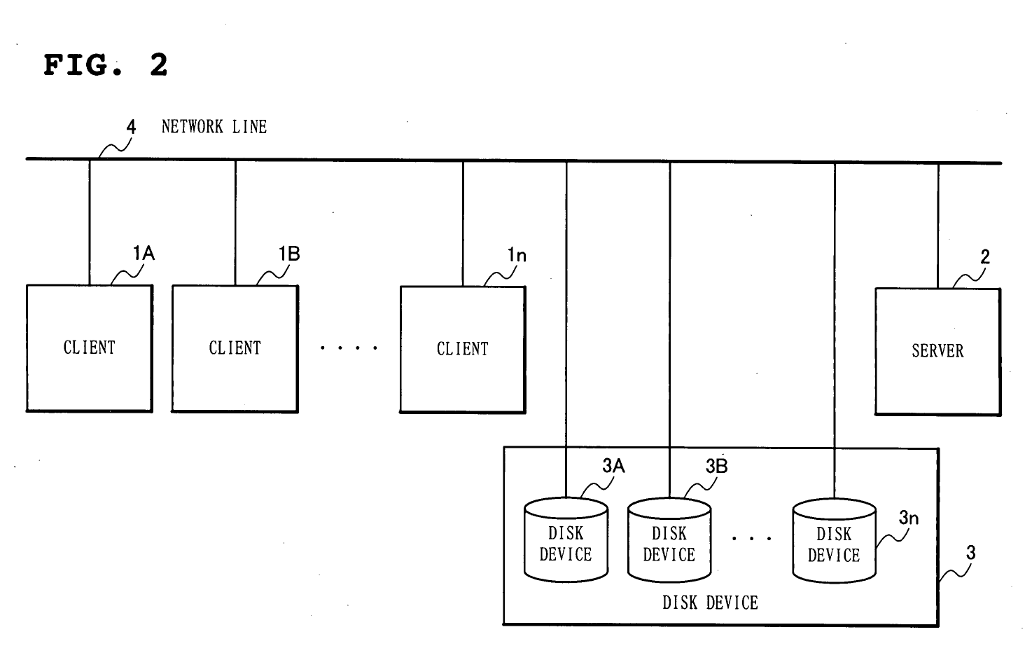

FIGS. 1 and 2 are diagrams illustrating the configuration of a file sharing system according to an embodiment of the present invention; FIG. 1 is a block diagram illustrating a configuration unit example of the file sharing system, and FIG. 2 is a diagram generally illustrating the file sharing system.

Referring to FIGS. 1 and 2, the file sharing system according to the present embodiment comprises a client 1, a server 2 and a disk device 3, which are connected through network lines 4.

The file sharing system according to the present embodiment transmits and receives In/Out (I/O) information by a prescribed processing described below, and uses a control function for exclusive access to files to realize file sharing.

The client 1, which is a computational server and a super computer, for example, comprises an I/O request process 11, a transmission queue 12, a transmission process 13, a reception process 14, a reception queue 15, an interrupt processing 16 and a reception wait queue 17.

In addition, the client 1 transmits only control information to the server 2, and performs I/O processing by itself with the disk device 3, based on the control information received from the server 2.

The control information transmitted by the client 1 to the server 2 is information contained in the I/O information, which is information on the I/O processing, and comprises I/O request information indicating that the client 1 requests information for determining an area targeted for I/O between the disk device 3 and the client 1, or I/O termination notification information whereby the client 1 notifies that the I/O processing between the disk device 3 and the client 1 is to be terminated.

Meanwhile, the control information received by the client 1 from the server 2 comprises I/O target determination information.

The I/O target determination information includes information on the target file system and the target file requested by the client 1 for I/O processing, and, based on the determination of the client 1 that transmitted the I/O request information and the I/O request process 11 in the client 1 that transmitted the I/O request information, information regarding the physical position of the applicable disk device 3 and the I/O target in the disk device 3, whether to read from or write to the disk whose position has been determined, and the address on the network line 4 of the client 1 that transmitted the I/O request information.

The I/O request process 11 has a function for generating a packet containing, among the I/O information required for I/O, only the I/O request information as control information, adding the packet to the transmission queue 12 and activating the transmission process 13, and comprises an I/O request means 111, a packet wait means 112, a packet determination means 113, an I/O issuing means 114, a protocol conversion means 115 and an I/O processing termination means 116.

The I/O request process 11 has a function for searching the reception queue 15 after the packet is added to the very end of the transmission queue 12 by the I/O request means 111, or after an I/O is issued to the disk device 3 through the protocol conversion 115; if no receiving packet for the I/O request corresponding to the I/O request process 11 itself is present in the reception queue 15, the I/O request process 11 adds the process of itself (I/O request process 11) to the very end of the reception wait queue 17, releases the CPU, and enters a state where the I/O request process waits at the packet wait means 112 for the reception queue 15 to receive the receiving packet for the I/O request.

In addition, the I/O request process 11 is a process for executing a user program, by invoking from the user program a system call such as read/write for performing I/O on the disk, enters the operating system (OS) of the client 1 and executes the procedure of each means such as the above I/O request means 111.

The I/O request means 111 has a function for generating, as control information, a packet containing the I/O request information and adding the packet to the very end of the transmission queue 12 before activating the transmission process 13.

The packet wait means 112 has a function for releasing the CPU to hold a reception wait state until the means is activated by the transmission process 14, and a function for providing the packet taken out of the reception queue 15 to the packet determination means 13.

The packet determination means 113 has a function for determining, through the packet wait means 112, whether the packet taken out of the reception queue 15 is I/O target determination information regarding the I/O, or I/O termination processing notification information, if the packet has been determined as the I/O target determination information, providing the packet to the I/O issuing means 114, on the other hand, if the packet has been determined as the I/O termination processing notification information, providing the packet to the I/O processing termination means 116.

The I/O issuing means 114 has a function for creating, based on the I/O target determination information provided by the packet determination means 113, I/O information for actually determining the target to perform I/O processing on and performing I/O, converting the created I/O information into a format suitable for an I/O protocol such as SCSI, and providing the I/O information to the protocol conversion means 115.

The protocol conversion means 115 has a function for transmitting the I/O information converted into the format suitable for the I/O protocol and provided by the I/O issuing means 114, using the protocol of a network such as TCP/IP, through the network line 4, to the applicable disk device 3, and actually performing the I/O.

The I/O processing termination means 116 has a function for returning to the calling read/write system call, the size of the I/O that could actually be performed between the client 1 and the disk device 3 and error information, which have been acquired from the I/O termination processing notification information provided by the packet determination means 113.

The transmission queue 12 has a function for storing and providing the transmission process 13 with a packet containing the I/O request information added by the I/O request means 111, and a packet containing the I/O termination processing notification information added by the interrupt processing 16.

The transmission process 13 has a function for checking the content of the packet in the transmission queue 12 for a destination server 2. The transmission process 13 comprises a transmission means 131 for transmitting this packet to the same server 2.

The reception process 14 comprises a reception means 141 for receiving a packet from the server 2, upon reception of a packet from the server 2, returns from the reception wait state, based on the information inside the same packet, searches the reception wait queue 17 to determine and activate the applicable I/O request process 11, and adds the received packet to the reception queue 15.

The reception queue 15 has a function for storing and providing the I/O request process 11 with the packet added by the reception process 14.

The interrupt processing 16 receives a packet that responds to a signal notifying the termination of the I/O and transmitted by the I/O request process 11 to the applicable disk device 3, from the disk device 3 through the network line 4, takes out the I/O termination notification approving the termination of the I/O from the received packet to generate the I/O termination notification information, which is added to the transmission queue 12 as control information, and activates the transmission process 13.

The reception wait queue 17 has, in case where, after the I/O request means 111 queues a packet in the transmission queue 12, or after the protocol conversion means 115 issues an I/O to the disk device 3, no receiving packet for the I/O request corresponding to the I/O request process 11 itself is present in the reception queue 15, a function for queuing an I/O request process 11.

The server 2 connects to the client 1 and the disk device 3 through the network line 4, comprises a reception process 21, an I/O request information queue 22, an I/O termination notification information queue 23, an I/O processing process 24, a transmission queue 25 and a transmission process 26, receives from the client 1 control information on the I/O and transmits to the client 1 information that determines the disk device 3 targeted for the I/O or information that notifies of the completion of the I/O termination processing.

The reception process 21 comprises a reception means 211 for receiving from a client 1 a packet relating to control information, and a packet determination means 212 for determining whether the packet received by the reception means 211 has I/O request information or I/O termination notification information, and has a function for, if the received packet has the I/O request information, adding the packet to the I/O request information queue 22, on the other hand, if the received packet has the I/O termination notification information, adding the packet to the I/O termination notification information queue 23.

The I/O request information queue 22 has a function for storing and providing the I/O processing process 24 with the packet having the I/O request information provided by the reception process 21.

The I/O termination notification information queue 23 has a function for storing and providing the I/O processing process 24 with the packet having the I/O termination notification information provided by the reception process 21.

The I/O processing process 24 has a function for taking out the packet having the I/O request information from the I/O request information queue 22, or taking out the packet having the I/O termination notification information from the I/O termination notification information 23, upon which a prescribed processing is performed, and adding the packet to the transmission queue 25, and comprises an I/O request information selection means 241, a file system management means 242 and an I/O termination processing notification means 243.

The I/O processing process 24 operates in a one-to-one correspondence with the I/O request process 11 identified by I/O identification number contained in the I/O request information and the I/O termination notification information.

The I/O request information selection means 241 has a function for determining, from the content of the packet having the I/O request information taken out from the I/O request information queue 22, the I/O target such as a target file system or a target file, which the client 1 is requesting to perform I/O on.

The file system management means 242 manages a file system (not shown), which has the disk device 3 as a component, with a hierarchical structure, and has the management information of the file system including disk determination information determining the disk device 3 and a constitution disk comprised in the disk device 3.

The file system management means 242 has a function for generating a packet comprising I/O target determination information containing the I/O request information selected by the I/O request information selection means 241, and the I/O identification number identifying the client 1 that issued the I/O request information and the I/O request process 11 within the client 1, adding the packet to the transmission queue 25, and activating the transmission process 26.

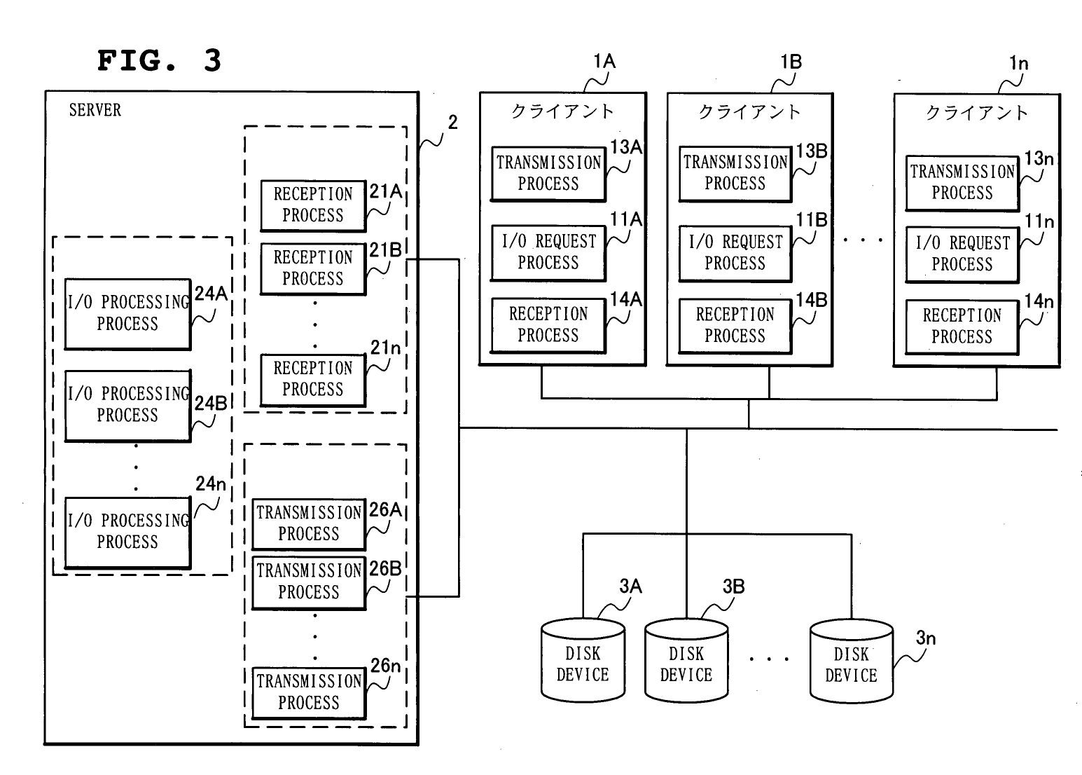

FIG. 3 is a block diagram illustrating an example of the configuration of the file sharing system according to the embodiment of the present invention.

Referring to FIG. 3, the differences from FIG. 1 are: a plurality of clients 1 and disk devices 3 (clients 1A, 1B and 1C and disk devices 3A, 3B and 3C) are connected to the network 4; the server 2 has reception processes 21A, 21B and 21C, I/O processing processes 24A, 24B and 24C, and transmission processes 26A, 26B and 26C corresponding to the I/O request processes 11A, 11B and 11C, the transmission processes 13A, 13B and 13C, and the reception processes 14A, 14B and 14C, respectively owned by each of the clients 1A-1C.

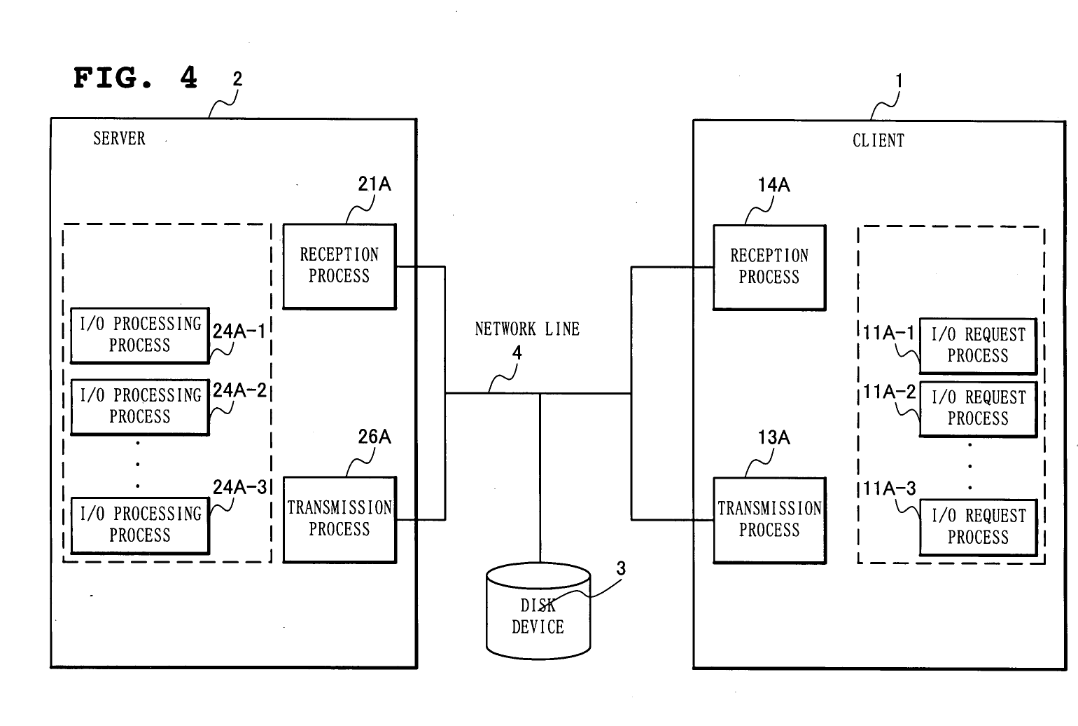

FIG. 4 is a block diagram illustrating another example of the configuration of the file sharing system according to the embodiment of the present invention.

Referring to FIG. 4, the differences from FIG. 1 are: the client 1 has a plurality of I/O processes 11 (11A-1, 11A-2 and 11A-3), and when each I/O request process 11 invokes a system call to perform I/O request, the server 2 has I/O processing processes 24A-1 to 24A-3 corresponding to each I/O request processes 11A-1 to 11A-3.

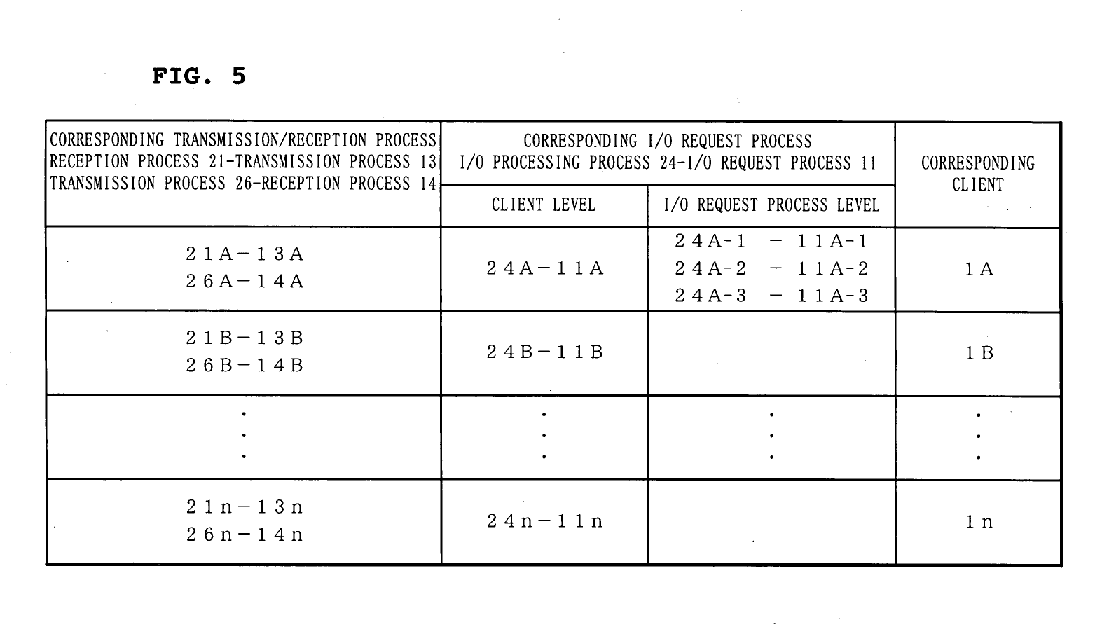

Moreover, FIG. 5 is a diagram representing correspondences indicated by I/O identification numbers, the correspondence being stored by the file system management means 242 when receiving a packet containing I/O request information.

Referring to FIG. 5, for each I/O request information in the client 1 that issued a plurality of pieces of I/O request information and the server 2, correspondences between the reception processes and the transmission processes, and correspondences between the I/O processing processes and the clients (client level) are described by client. Further, correspondences between the I/O request processes and the I/O processing processes (I/O processing process level) are described in the case where one client issues a plurality of pieces of I/O request information.

According to the information indicating the I/O identification numbers comprised in the I/O request information, even if there are a plurality of clients, the file system management means 242 can identify the client that issued the I/O request information, meanwhile, even if there are a plurality of I/O request processes in one client that issued different I/O request information, the file system management means 242 can identify the I/O request process that issued the I/O request information.

Furthermore, the file system management means 242 has a function for updating the management information of the file system based on the content of the packet comprised in the I/O termination notification information taken out of the I/O termination notification information queue 23, generating a packet containing error information, the size of I/O that could actually be performed between the client 1 and the disk device 3, and the identification information of the client 1 that transmitted the I/O termination notification information, and providing the packet to the I/O termination processing notification means 243.

The I/O termination processing notification means 243 has a function for generating, based on the content of the packet provided by the file system management means 242, a packet containing the I/O termination processing notification information for notifying that I/O termination processing has been performed in the server 2, adding the packet to the transmission queue 25, and activating the transmission process 26.

The transmission queue 25 has a function for storing and providing the transmission process 26 with the packet containing the I/O target determination information or the I/O termination processing notification information provided by the I/O processing process 24.

The transmission process 26 comprises a transmission means 261 for transmitting the packet taken out of the transmission queue 25 to the client 1.

The disk device 3 is connected to the client 1 and the server 2 through the network line 4, comprises a protocol conversion means 31 for taking out a command based on an I/O protocol such as SCSI from the I/O information in response to the I/O target determination information received from the client 1, and performs I/O processing based on the same commands as common disk devices.

In addition, the transmission queue 12, the reception queue 15, the reception wait queue 17, the I/O request information queue 22, the I/O termination notification information queue 23 and the transmission queue 25 have a queue structure for handling data in a data I/O scheme called First In First Out (FIFO). Since FIFO is a scheme whereby stored data is taken out in the order in which the data was stored, the data that is stored most recently is taken out last.

Although, for simplicity, the file sharing system shown in FIG. 1 comprises only one client 1, one server 2 and one disk device 3, practically, the present invention aims at a case where one server, a plurality of clients and a plurality of disk devices are connected through the network line 4 as shown in FIG. 2, a plurality of clients request I/O from the server, and a plurality of clients directly access the disk device through the network line 4.

The reception process 21 and the transmission process 26 in the server 2 are in a one-to-one relationship with the transmission process 13 and the reception process 14 in the client 1. Therefore, if there are a plurality of clients, the same number of reception processes 21 and transmission processes 26 as that of the clients exist in the server 2.

Furthermore, the I/O processing process 24 in the server 2 is occupied by one I/O request information until the processing of the I/O request information is completed in the server 2. For this reason, each of a plurality of I/O request processes 11 in the client 1 invokes a read/write system call from a user program to enter inside the OS executing the procedures of the I/O request means 111, thus, if a plurality of I/Os are requested, in order for the server 2 to process a plurality of pieces of I/O request information, a plurality of I/O processing processes 24 corresponding one-to-one to a plurality of I/O request processes 11 are activated.

In addition, the I/O processing process 24 corresponds to the I/O request process 11 that issued the I/O request information to be processed based on the I/O identification number, which is specific identification information comprised in the received I/O request information.

Next, a summary of the operation of the main components in the file sharing system according to the embodiment of the present invention will be described.

When the read/write system call is invoked in a user mode, in the I/O request process 11, the I/O request means 111 generates and adds to the very end of the transmission queue 12 a packet containing only I/O request information as control information regarding I/O, and then activates the transmission process 13.

Thereafter, the I/O request process 11 searches the reception queue 15, and if no receiving packet for the I/O request corresponding to the I/O request process 11 itself is present in the reception queue 15, the I/O request process 11 adds the process of itself (I/O request process 11) to the very end of the reception wait queue 17, releases the CPU, and enters a state where I/O request process waits to be activated by the reception process 14.

When the I/O request process 11 is activated by the reception process 14, the packet determination means 113 searches the reception queue 15 and takes out the applicable packet, and refers to a flag in the packet to determine whether the packet is I/O target determination information or I/O termination processing notification information.

As a result of the determination by the packet determination means 113, if the packet is the I/O target determination information, the I/O issuing means 114 determines which disk device 3 performs I/O based on the I/O target determination information. Then, the I/O information corresponding to the I/O target determination information is converted into a format suitable for an I/O protocol such as SCSI, and provided to the protocol conversion means 115.

Then, the protocol conversion means 115 transmits the I/O information converted into the format suitable for the I/O protocol and provided by the I/O issuing means 114, using the protocol of a network such as TCP/IP, through the network line 4, to the applicable disk device 3.

Thereafter, the I/O request process 11 searches the reception queue 15, and if no receiving packet for the I/O request corresponding to the I/O request process 11 itself is present in the reception queue 15, the I/O request process 11 adds the process of itself (I/O request process 11) to the very end of the reception wait queue 17, releases the CPU, and enters the state again where the I/O request process to be activated by the reception process 14.

Meanwhile, as a result of the determination by the packet determination means 113, if the packet is the I/O termination processing notification information, the I/O processing termination means 116 acquires the error information and the size of the I/O that could actually be performed from the I/O termination processing notification information, and returns them to the calling read/write system call.

When the transmission process 13 is activated, the transmission means 131 takes out one packet at the beginning of the transmission queue 12 to check the content of the packet for a destination server 2, and transmits this packet to the server 2. Thereafter, the transmission process 13 uses the transmission means 131 to check the transmission queue 12 again, and if there is no further packet, the transmission process releases the CPU, and enters a transmission wait state.

The reception process 21 is in a reception wait state in the reception means 211. Upon reception of the packet from the client 1, the reception process activates, refers to the flag in the received packet, and checks whether the received packet is the I/O request information from the client 1 or the I/O termination notification information.

If the packet is the I/O request information, the reception process adds the packet to the very end of the I/O request information queue 22, and activates one I/O processing process 24 that is currently not in process.

Meanwhile, if the packet is the I/O termination notification information, the reception process adds the packet to the very end of the I/O termination notification information queue 23, and activates the corresponding I/O processing process 24.

If the packet received from the client 1 is the I/O request information, the reception process 21 activates an I/O processing process 24 that is currently not in process, that is, an I/O processing process 24 that is currently in an I/O request information wait state (waiting for an I/O processing start).

Then, the activated I/O processing process 24 uses an I/O request information selection means 241 to check the I/O request information queue 22, and, if there is a packet in the I/O request information queue 22, the I/O processing process 24 takes out one packet from the beginning of the queue.

The file system management means 242 determines a target file system targeted for I/O, a target file targeted for I/O request, the client 1 that transmitted the I/O request information and the I/O request process 11 in the client 1 that transmitted the I/O request information based on the content of the packet acquired from the I/O request information selection means 241, generates a packet containing information regarding the physical position of the applicable disk system 3 and the I/O target in the disk device 3, whether to read from or write to the disk whose position has been determined, and the address on the network line 4 of the client 1 that transmitted the I/O request information, stores the packet to the very end of the transmission queue 25, and activates the transmission process 26.

Accordingly, the packet stored in the transmission queue 25 contains I/O target determination information comprising information contained in the packet acquired by the file system management means 242 from the I/O request information selection means 241, and information newly added by the file system management means 242.

Thereafter, the I/O processing process 24 temporarily releases the CPU, and enters a wait state for the I/O termination notification information transmitted by the client 1 (I/O processing termination wait state) in the file system management means 242.

Meanwhile, if the packet received from the client 1 is I/O termination notification information, the I/O processing process 24 activated by the reception process 21 and currently in the I/O processing termination wait state (waiting for I/O processing notification information) searches the I/O termination notification information queue 23, takes out the packet containing the applicable I/O termination notification information from the I/O termination notification information queue 23, and provides the packet to the file system management means 242.

Then, the file system management means 242 updates management information to be managed based on the packet containing the received I/O termination notification information, generates a packet containing information regarding error information, the size of the I/O that could actually be performed, and the address on the network line 4 of the client 1 that issued the I/O request information, and transmits the packet to the I/O termination processing notification means 243.

The I/O termination processing notification means 243 generates, based on the content of the packet provided by the file system management means 242, a packet containing the I/O termination processing notification information for notifying that I/O termination processing has been performed in the server 2, adds the packet to the transmission queue 25, and activates the transmission process 26.

When the transmission process 26 is activated by the I/O processing process 24, the transmission means 261 checks the transmission queue 25, and, if there is a packet in the transmission queue 25, the transmission means takes out one packet from the beginning of the queue, refers to the address on the network line 4 of the client 1 that is a destination in the packet to transmit the packet to the client 1.

Thereafter, the transmission process 26 uses the transmission means 261 to check the transmission queue 25 again, and if there is no further packet, the transmission process releases the CPU, and enters a transmission wait state.

The reception process 14, upon reception of a packet from the server 2, returns from the reception wait state, based on the information inside the same packet, searches the reception wait queue 17 to determine and activate the applicable I/O request process 11, and adds the received packet to the very end of the reception queue 15.

The interrupt processing 16 receives from the disk device 3 through the network line 4, a packet (comprising termination notification) responding to a packet that terminates the I/O, which has been converted into a format suitable for an I/O protocol by the protocol conversion means 115 and transmitted to the disk device 3.

In so doing, the interrupt processing 16, in an extension of the interrupt processing within the operating system, takes out the termination notification based on the I/O protocol from the packet received from the disk device 3, and invokes a call back function of the disk driver. Then, the interrupt processing 16 generates I/O termination notification information from the error information of the I/O, adds the information to the very end of the transmission queue 12, and activates the transmission process 13.

The protocol conversion means 31 in the disk device takes out a command based on an I/O protocol such as SCSI, from the I/O information received from the client 1 through the network line 4, and performs I/O processing based on the command as common disk devices.

(Description of Operation of File Sharing System)

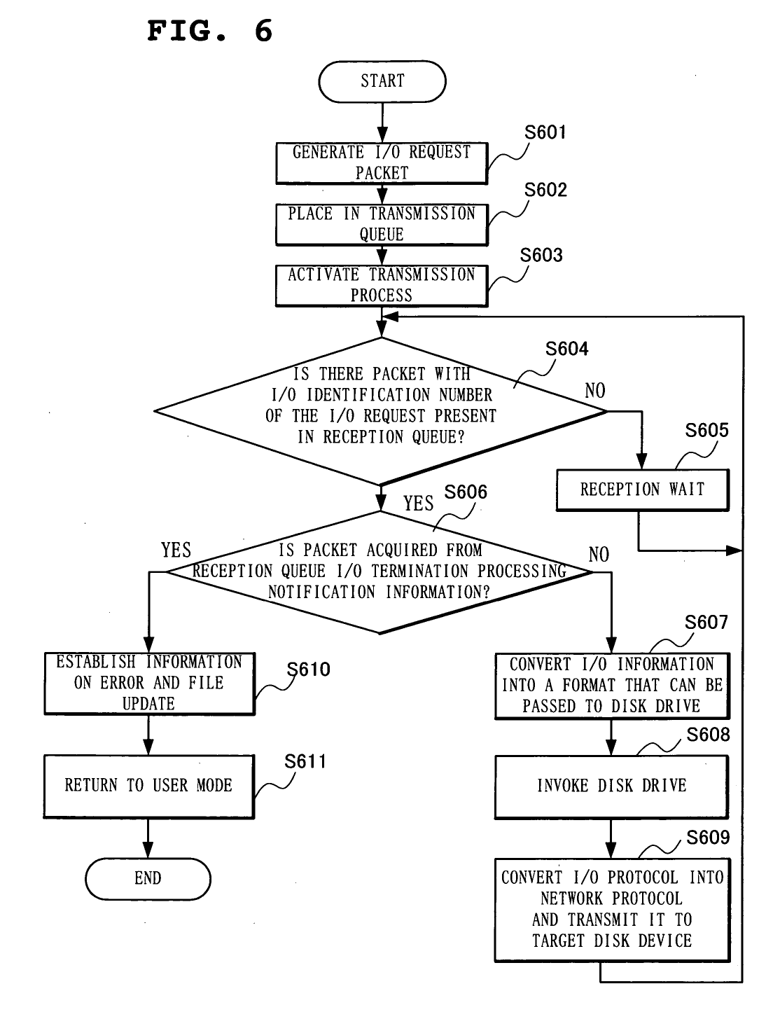

Next, the operation of the file sharing system according to the present embodiment will be described in detail by referring to FIG. 1 and flow charts of FIGS. 6-12.

FIG. 6 is a flow chart illustrating an operation of I/O request process 11 of the file sharing system according to the present embodiment.

According to FIG. 6, the I/O request process 11 generates an I/O request packet (Step S601), which is control information regarding the I/O containing file identification information, a file offset, an I/O size, authentication information, an I/O identification number and a packet identification flag, places the I/O request packet in the transmission queue 12 (Step S602) and activates the transmission process 13 (Step S603).

The I/O request packet is a packet comprising I/O request information, which indicates that the client 1 requests from the server 2 information on the target file system and the target file targeted for the I/O request, and information on the physical position of the applicable disk device 3 and the I/O target in the disk device 3.

Then, upon transmission by the server 2 in response to the I/O request packet transmitted by the I/O request process 11, the I/O request process 11 determines whether or not the packet that has been queued in the reception queue 15 has the I/O identification number of the I/O request (Step S604), and enters a packet reception wait state (Step S605) if the packet has been determined to not have the I/O identification number of the I/O request.

If the packet has been determined to have the I/O identification number of the I/O request in Step S604, or if the I/O request process 11 is activated by the reception process 14 in Step S605 to perform determination again in Step S604, and the packet queued in the reception queue 15 has been determined to have the I/O identification number of the I/O request, the I/O request process 11 takes out the packet from the reception queue 15.

Then, the I/O request process 11 refers to a packet identification flag in the packet, and determines whether or not the packet has the I/O termination processing notification information (Step S606).

In Step S606, if the packet has been determined to not have the I/O termination processing notification information, that is, determined to have I/O target determination information, the I/O request process 11 converts I/O information corresponding to the I/O target determination information into a format that can be passed to a disk driver (Step S607) and invokes the disk driver (Step S608), then places a command on a network protocol for transmission to the target disk device 3, and performs the I/O with the disk 3 (Step S609).

In the foregoing, if a plurality of pieces of information regarding the physical position of the disk 3 targeted for the I/O target determination information are included, or if a plurality of pieces of information regarding the physical position of the target constitution disk comprised in the disk device 3 are included, the I/O request process 11 repeats Steps S607-S609 by the same number of times.

Thereafter, the I/O request process performs determination again in Step S604, and if no packet with an I/O identification number is present, the I/O request process releases the CPU, and enters a reception wait state in Step S605.

In Step S606, if the information has been determined to be the I/O termination processing notification information, the I/O request process 11 returns error information, file update information and the size of I/O that could actually be performed to the calling read/write system call (Step S610), and turns back into the user mode (Step S611).

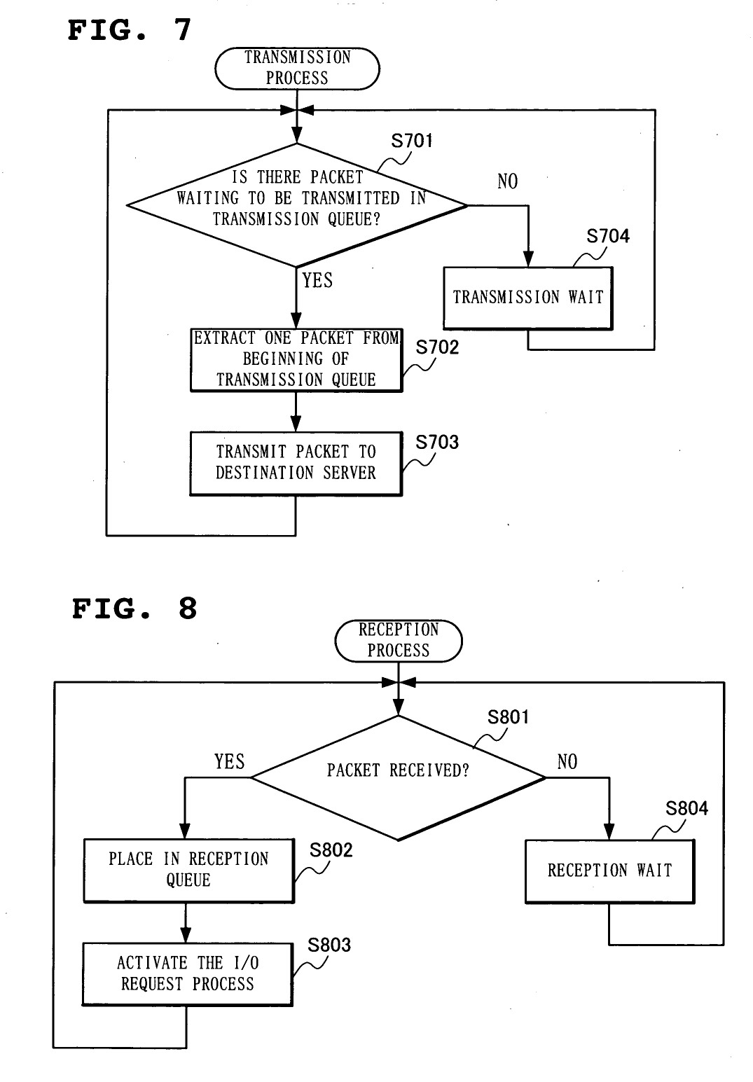

FIG. 7 is a flow chart illustrating an operation of the transmission process 13 of the file sharing system according to the present embodiment.

According to FIG. 7, when the transmission process 13 is activated by the I/O request means 111 in the I/O request process 11, or from within a call back function of the interrupt processing 16, the transmission process 13 determines whether or not there is a packet waiting to be transmitted in the transmission queue 12 (Step S701).

In Step S701, if the transmission process 13 determines that there is a packet waiting to be transmitted in the transmission queue 12, the transmission process 13 takes out one packet from the beginning of the transmission queue 12 (Step S702), checks the content of the packet for the address on the network of the destination server 2, and transmits the packet to the address (Step S703).

In Step S701, if the transmission process 13 determines that there is no packet waiting to be transmitted in the transmission queue 12, the transmission process 13 releases the CPU and enters a transmission wait state (Step S704).

Thereafter, the transmission queue 12 is checked again (Step S701), if there is a packet, Steps S702 and S703 are repeated, on the other hand, if there is no further packets, the CPU is released and the transmission process enters a transmission wait state (Step S704).

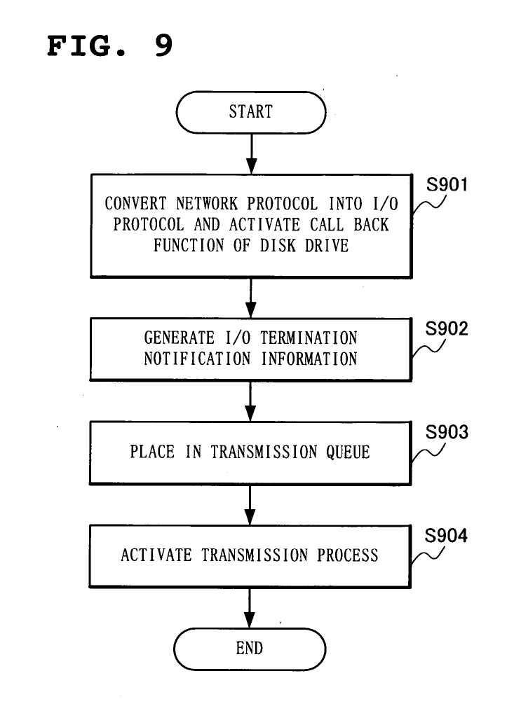

FIG. 8 is a flow chart illustrating an operation of the reception process 14 of the file sharing system according to the present embodiment.

According to FIG. 8, when the client 1 receives a packet transmitted by the server 2, the reception process 14, which has stopped within a reception processing function to wait for the reception of a packet, is activated by a function of the operating system. The activated reception process 14 determines whether or not a packet from the server 2 is present (Step S801), and if there is reception of a packet, adds the received packet to the very end of the reception queue 15 (Step S802).

Then, the reception process searches the reception wait queue 17 with, as a key, the I/O identification number in the packet that was referred to while adding the packet in Step S802, and activates the applicable I/O request process 11 (Step S803).

On the other hand, if there is no reception of a packet in Step S801, the reception process enters a reception wait state within the function (Step S804).

Thereafter, the reception process invokes the reception processing function again to determine whether or not there is reception of a packet from the server 2 (Step S801), if there is a received packet, the reception process repeats Steps S802 and S803, on the other hand, if there is no further received packet, the reception process enters a reception wait state within the function (Step S804).

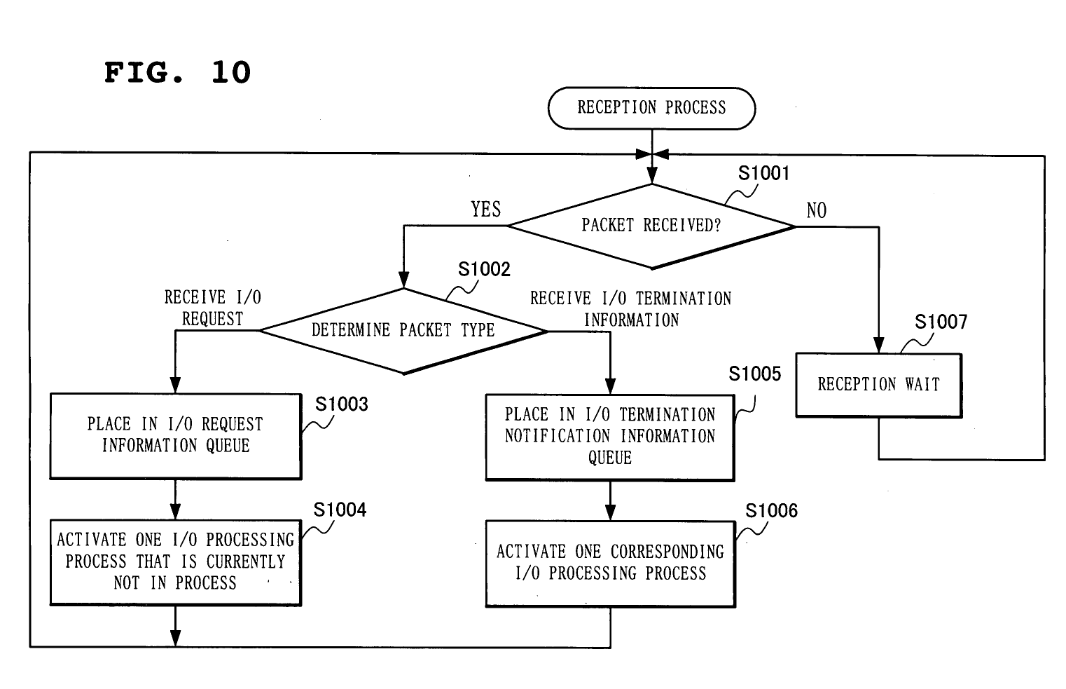

FIG. 9 is a flow chart illustrating an operation of the interrupt processing 16 of the file sharing system according to the present embodiment.

According to FIG. 9, the interrupt processing 16 is performed upon reception of the I/O termination notification from the disk device 3. Since the I/O termination notification transmitted from the disk device 3 is transmitted to the client 1 through the network line 4, only the I/O protocol in the notification is taken out, and the call back function of the disk drive is activated (Step S901).

The call back function checks the error information or the like and generates an I/O termination notification information. Namely, a packet to which an I/O identification number and a packet identification flag have been added is generated as an I/O termination notification information (Step S902).

Then, the packet generated in Step S902 is added to the very end of the transmission queue 12 (Step S903), and the transmission process 13 is activated (Step S904).

However, if the I/O request process 11 transmitted a plurality of commands to the disk device 3, the procedure proceeds to Step S903 when the reception of a number of I/O transmission notifications corresponding to the number of transmitted commands is confirmed in the above Step S902.

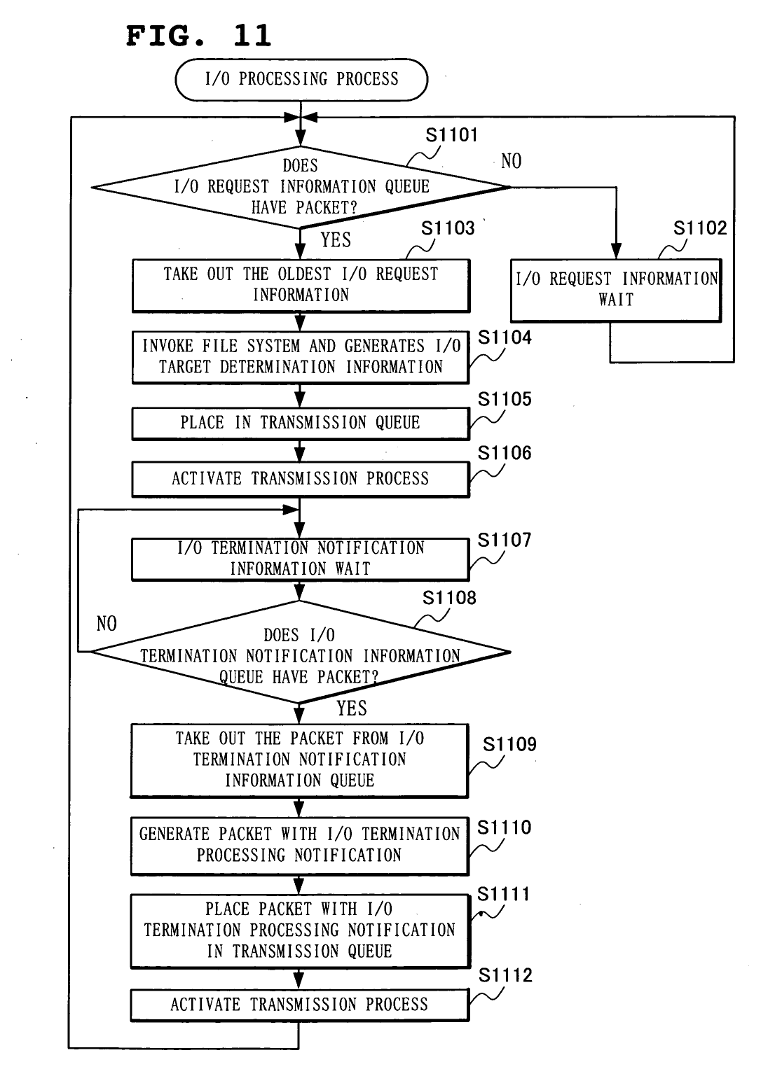

FIG. 10 is a flow chart illustrating an operation of the reception process 21 of the file sharing system according to the present embodiment.

According to FIG. 10, when the server 2 receives a packet transmitted by the client 1, the reception process 21, which has been in the reception wait state within a reception processing function to wait for the reception of a packet, is activated by a function of the operating system. The activated reception process 21 determines whether or not a packet has been received (Step S1001), and if a packet has been received, the reception process refers to the packet identification flag within the packet to determine the type of the packet (Step S1002).

In Step S1002, if the type has been determined to be I/O request information, the reception process adds the process number of the transmission process 13 corresponding to the reception process 21 to the packet, adds the packet to the very end of the I/O request information queue 22 (Step S1003), and activates the I/O processing process 24 that is currently not in process (waiting for I/O processing start) (Step S1004).

On the other hand, in Step S1002, if the type has been determined to be I/O termination notification information, the reception process adds the process number of the transmission process 13 corresponding to the reception process 21 to the packet, adds the packet to the very end of the I/O termination notification information queue 23 (Step S1005), and activates the I/O processing process 24 corresponding to the I/O request based on the process number and the I/O identification number (Step S1006).

If there is no reception of a packet in Step S1001, the reception process enters a reception wait state within the function (Step S1007).

Thereafter, the reception process invokes the reception processing function again to determine whether or not there is reception of a packet (Step S1001), if there is a received packet, the reception process repeats Steps S1002-S1004, or Steps S1002-S1005-Step S1006, on the other hand, if there is no further received packet, the reception process enters a reception wait state within the function (Step S1007).

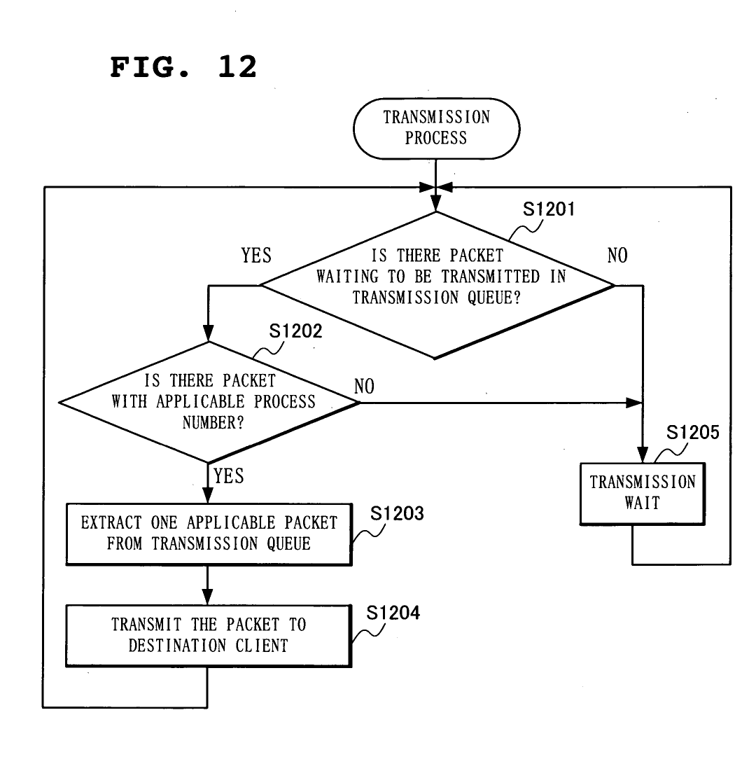

FIG. 11 is a flow chart illustrating an operation of the I/O processing process 24 of the file sharing system according to the present embodiment.

First, the reception process 21 activates the I/O processing process 24 as shown in the above Step S1004.

According to FIG. 11, the I/O processing process 24 determines whether or not the I/O request information queue 22 has a packet (Step S1101), and if the I/O request information queue 22 has no packet, the I/O processing process waits until the I/O request information queue 22 has a packet (Step S1102).

On the other hand, if the I/O request information queue 22 has a packet, the I/O processing process 24 takes out the oldest packet among the packets stored in the I/O request information queue 22 from the beginning of the I/O request information queue 22 (Step S1103).

Based on the content of the packet, the file system management means 242 determines the target file system and the target file, generates a packet containing information (I/O target determination information) regarding the physical position of the applicable disk system 3 and the I/O target in the disk device 3 (starting sector number and the number of sectors), whether to read from or write to the constitution disk comprised in the disk device 3, the address on the network of the client 1 that transmitted the I/O request information, the I/O identification number and the packet identification flag (Step S1104), adds the packet to the very end of the transmission queue 25 (Step S1105), and activates the transmission process 26 that has the process number specified by the reception process 21 (Step S1106).

In addition, the I/O target file may reside on a plurality of disk devices 3, or the physical location on the constitution disk comprised in the disk device 3 may be discontinuous, and divided into a plurality of areas.

Thus, in such case, a plurality of pieces of information regarding the physical location of the I/O target must be stored in the packet, in the above Step S1103. The physical location of the I/O target means, for example, a write start position or a read start position described by the start sector number and the number of sectors of the specified disk.

Thereafter, the I/O processing process 24 releases the CPU temporarily, and enters a reception wait state for the control information (I/O termination notification information) from the client 1 (Step S1107).

Then, the reception process 21 activates the I/O processing process 24 corresponding to the I/O termination notification information, as shown in the above Step S1006, and the activated I/O processing process 24 determines whether or not the I/O termination notification information queue 23 has a packet (Step S1108).

If the I/O termination notification information queue 23 has a packet, the I/O processing process 24 searches the packet containing the applicable I/O termination notification information with, as a key, the I/O identification number acquired from the I/O request information at the reception of the I/O request information and takes out the packet from the I/O termination notification information queue 23 (Step S1109).

On the other hand, if the I/O termination notification information queue 23 has no packet, the procedure returns to Step S1107, and the I/O processing process 24 enters the reception wait state for the I/O termination notification information from the client 1.

Then, the file system management means 242 updates the management information of the file system, generates a packet containing error information, the size of I/O that could actually be performed, and information on the address on the network of the client 1 that transmitted the I/O termination notification information, the I/O identification number, and the packet identification flag (Step S1110), and provides the packet to the I/O termination processing notification means 243.

Then, the I/O termination processing notification means 243 generates I/O termination processing notification information for notifying that I/O termination processing has been performed in the server 2 based on the content of the packet provided by the file system management means 242, adds the packet to the very end of the transmission queue 25 (Step S1111), and activates the transmission process 26 that has the process number specified by the reception process 21 (Step S1112).

Then, when the I/O processing process 24, which was activated by the reception process 21, is completed, the I/O processing process according to the present embodiment returns and repeats from Step S1101, when the reception process 21 activates the I/O processing process 24 again.

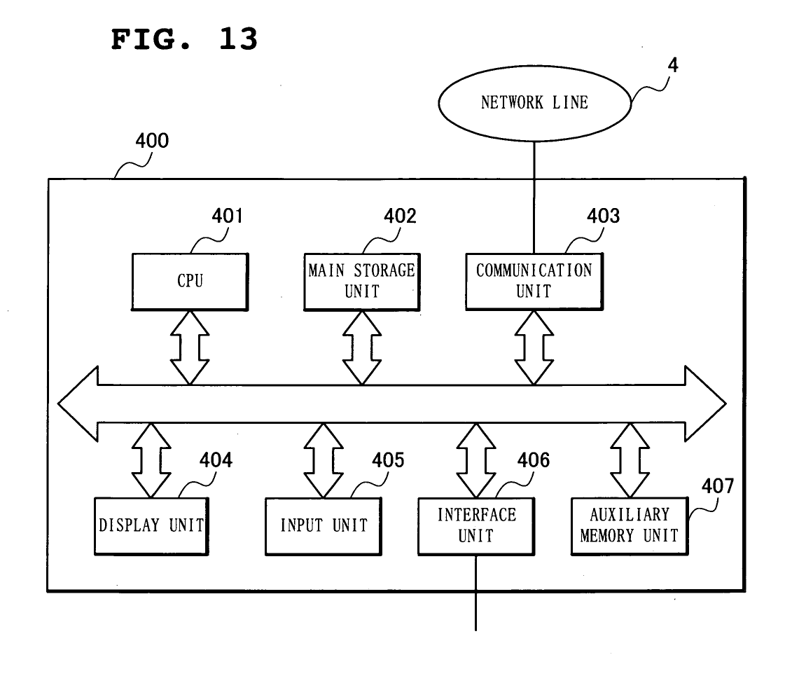

FIG. 12 is a flow chart illustrating an operation of the transmission process 26 of the file sharing system according to the present embodiment.

According to FIG. 12, the transmission process 26 is activated by the file system management means 242 in the I/O processing process 24 or by the I/O termination processing notification means 243, and determines whether or not there is a packet waiting to be transmitted in the transmission queue 25 (Step S1201).

If there is a packet waiting to be transmitted in the transmission queue 25 in Step 1201, the transmission process 26 determines whether or not there is a packet that has the same process number as that of the process of itself (Step S1202).

In Step S1202, if the transmission process determines that there is a packet that has the same process number as that of the process of itself, the transmission process takes the packet from the beginning of the transmission queue 25 (Step S1203), checks the address on the network of the destination client 1 based on the content of the packet, and transmits the packet to the client 1 that has the address (Step S1204).

On the other hand, if there is no packet waiting to be transmitted in Step S 1201, and there is no packet that has the same process number as that of the process of itself in Step S1202, the transmission process 26 releases the CPU and enters a transmission wait state (Step S1205).

Thereafter, the transmission process determines whether or not there is a packet waiting to be transmitted in the transmission queue 25 again (Step S1201), if there is a packet waiting to be transmitted, the transmission process determines whether or not there is a packet that has the same process number as that of the process of itself again (Step S1202), if there is a packet that has the same process number as that of the process of itself, the transmission process repeats Steps S1203 and S1204, on the other hand, if there is no packet waiting to be transmitted in Step S1201, or if there is no packet that has the same process number as that of the process of itself in Step 1202, the transmission process releases the CPU and enters the transmission wait state (Step S1205).

In addition, in the foregoing, when the transmission queue 12, the reception queue 15, the reception wait queue 17, the I/O request information queue 22, the I/O termination notification information queue 23 and the transmission queue 25 are operated, exclusive access control must be used to prevent competition.

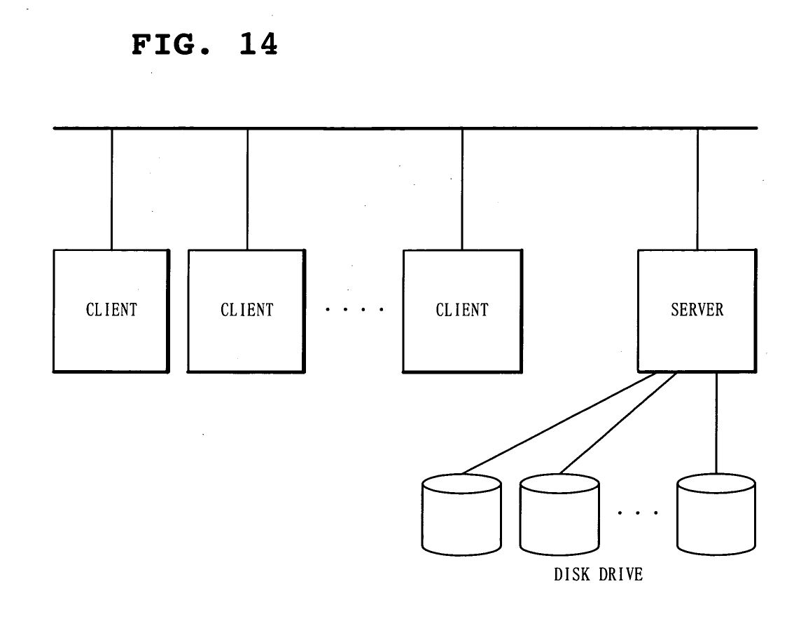

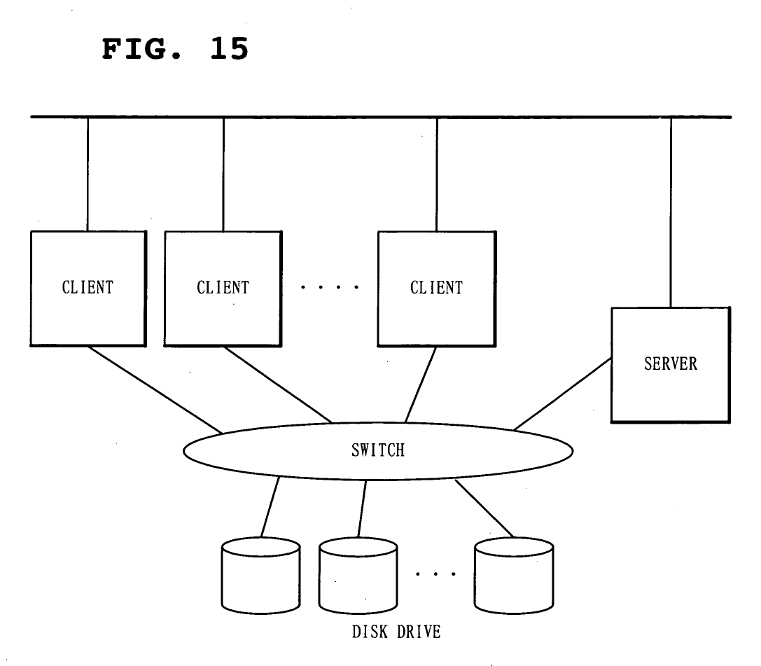

FIG. 13 is a block diagram illustrating the hardware configuration of a computer processor 400 on the file sharing system according to the embodiment of the present invention.

The computer processor 400 comprises a CPU 401, a main storage unit 402, which serves as main memory, a communication unit 403, which is connected to the network line 4 to transmit/receive data, a display unit 404 such as a display and a printer, an input unit 405 such as a keyboard and a mouse, an interface unit 406 for performing transmission/reception of data between peripheral devices, and an auxiliary memory unit 407 such as a magnetic disk, semiconductor memory and other storage media.

In addition to hardware, the operation of the file sharing system of the present embodiment may be achieved in software by executing on the CPU 401 of the computer processor a program, which executes each function of each of the above means, processes and the like. This program is stored in the auxiliary memory unit 407, and loaded from the auxiliary memory unit 407, through the main memory unit 402 and into the CPU 401 to control its operation, thus achieving the above-mentioned each function.

(Effect of Present Embodiment)

A first effect is the ability to use efficiently system resources such as memory and a CPU in the server 2.

The reason is, since the client 1 directly accesses the data on the disk device 3 through the network based on determination information transmitted by the server 2, the data targeted for I/O does not pass through the server 2.

A second effect is the ability to achieve file sharing among the client 1, the server 2 and the disk device 3, which are located remotely such that SAN cannot be constructed using Fibre Channel or the like.

The reason is, since all of the client 1, the server 2 and the disk device 3 are connected to the network line 4, file sharing can be achieved even if SAN is not constructed in addition to the network line 4.

A third effect is that the disk device 3 need not be disposed at a location that is physically close to the server 2, since the client 1 can directly performs I/O of the data between the disk device 3 and the client 1 through the network line 4. Furthermore, since a plurality of disk devices 3 can be distributed over a plurality of locations on the network line 4, the risk of damages due to natural disaster such as earthquakes can be distributed, and the damages can be minimized even in case of disaster.

A fourth effect is that the file sharing system can be constructed easily and a system construction cost can be reduced since a further storage area network need not be constructed even when construction of a file sharing system is desired among a plurality of computers in a facility with an existing local area network, and high management skills are not required since system management can be performed easily.

A fifth effect is the ability to reduce operation cost since a storage area network does not have to be constructed, and the system administrator is not required to have skills for constructing and maintaining a storage area network using Fibre Channel or the like.

A sixth effect is the ability to achieve file sharing among computers distributed over a wide area such as grid computing, since the disk device 3 takes out of I/O information converted into a format suitable for the I/O protocol, commands based on an I/O protocol such as SCSI, through a general purpose network line for I/O processing.

Although the invention has been illustrated and described with respect to exemplary embodiment thereof, it should be understood by those skilled in the art that the foregoing and various other changes, omissions and additions may be made therein and thereto, without departing from the spirit and scope of the present invention. Therefore, the present invention should not be understood as limited to the specific embodiment set out above but to include all possible embodiments which can be embodies within a scope encompassed and equivalents thereof with respect to the feature set out in the appended claims.

What is claimed is:

1. A file sharing system whereby a plurality of client terminals shares data stored in at least one disk device through a networked management server, wherein
said disk device is disposed to be accessible by said client terminal through said network, and
said management server, based on the data input/output request from said client terminal, transmits to said client terminal, determination information comprising positional information on said disk device targeted for input/output request and the area targeted for the input/output request on said disk device.

2. A file sharing system whereby a plurality of client terminals shares data stored in at least one disk device through a networked management server, wherein
said disk device is disposed to be accessible by said client terminal through said network, and
said management server, based on the data input/output request from said client terminal, transmits to said client terminal, determination information comprising positional information on said disk device where said requested data is present and on the data.

3. The file sharing system as set forth in claim 1, wherein
said client terminal, based on said determination information that was transmitted by said management server, directly accesses the area or the data on said disk device through a network.

4. The file sharing system as set forth in claim 1, wherein
said management server receives a plurality of said input/output requests from said plurality of client terminals, and
transmits to said client terminal determined by the identification information of said client terminal contained in said input/output request, said determination information in response to the corresponding input/output request.

5. The file sharing system as set forth in claim 4, comprising
a table for corresponding said client terminal to said input/output request.

6. The file sharing system as set forth in claim 1, wherein
said management server, upon reception of the termination notification of access transmitted by said client terminal, updates the management information of the data on said disk device that has been changed by the access of said client terminal.

7. A file sharing program executed on a computer processor, whereby a plurality of client terminals shares data stored in at least one disk device through a networked management server, having a function causing
said computer processor to
execute a function whereby said management server, based on the data input/output request from said client terminal, transmits to said client terminal, determination information comprising positional information on said disk device targeted for input/output request disposed to be accessible by said client terminal through said network, and an area targeted for the input/output request on said disk device.

8. A file sharing program executed on a computer processor, whereby a plurality of client terminals shares data stored in at least one disk device through a networked management server, having a function causing
said computer processor to
execute a function whereby said management server, based on the data input/output request from said client terminal, transmits to said client terminal, determination information comprising positional information on said disk device where said requested data is present and which is disposed to be accessible by said client terminal through said network, and on the data.

9. The file sharing program as set forth in claim 7, having a function causing
said computer processor to
execute a function whereby said client terminal, based on said determination information that was transmitted by said management server, directly accesses the area or the data on said disk device through a network.

10. The file sharing program as set forth in claim 7, having a function causing
said computer processor to
execute a function whereby said management server receives a plurality of said input/output requests from a plurality of said client terminals, and
transmits to said client terminal determined by the identification information of said client terminal contained in said input/output request, said determination information in response to the corresponding input/output request.

11. The file sharing program as set forth in claim 10, having a function causing
said computer processor to
execute a function comprising a table for corresponding said client terminal to said input/output request.

12. The file sharing program as set forth in claim 7, having a function causing
execution of a function whereby said management server, upon reception of the termination notification of access transmitted by said client terminal, updates the management information of the data on said disk device that has been changed by the access of said client terminal.

13. A management server connecting through a network when a plurality of client terminals shares data stored in at least one disk device,
based on the data input/output request from said client terminal, transmitting to said client terminal, determination information comprising positional information on said disk device targeted for input/output request disposed to be accessible by said client terminal through said network, and an area targeted for the input/output request on said disk device.

14. A management server connecting through a network when a plurality of client terminals shares data stored in at least one disk device,
based on the data input/output request from said client terminal, transmitting to said client terminal, determination information comprising positional information on said disk device where said requested data is present and which is disposed to be accessible by said client terminal through said network, and on the data.

15. The management server as set forth in claim 13,
transmitting to said client terminal said determination information whereby said client terminal, based on said determination information that was transmitted by said management server, directly accesses the data on said disk device through a network

16. The management server as set forth in claim 13,
receiving a plurality of said input/output requests from a plurality of said client terminals, and
transmitting to said client terminal determined by the identification information of said client terminal contained in said input/output request, said determination information in response to the corresponding input/output request.

17. The management server as set forth in claim 16, comprising
a table for corresponding said client terminal to said input/output request.

18. The management server as set forth in claim 13,
upon reception of the termination notification of access transmitted by said client terminal, updating the management information of the data on said disk device that has been changed by the access of said client terminal.

19. A client terminal sharing data stored in at least one disk device through a networked management server, comprising the requirements of
requesting said management server for data input/output,
receiving determination information comprising positional information on said disk device targeted for said input/output request and an area targeted for the input/output request on said disk device from said management server, and
directly accessing data on said disk device, which is disposed to be accessed by said client terminal through said network, based on said determination information.

20. A client terminal sharing data stored in at least one disk device through a networked management server, comprising the requirements of
requesting said management server for data input/output,
receiving determination information comprising positional information on said disk device where data targeted for said input/output request is present and on the data from said management server, and
directly accessing, through the network, data on said disk device, which is disposed to be accessed by said client terminal through said network, based on said determination information.

21. A plurality of client terminals sharing data stored in at least one disk device through a networked management server, comprising the requirements of
requesting said management server for data input/output,
receiving determination information comprising positional information on said disk device targeted for said input/output request corresponding to said input/output request requested by the client itself, and an area targeted for the input/output request on said disk device from said management server, and
directly accessing data on said disk device, which is disposed to be accessed by said plurality of client terminals through said network, based on said determination information.

22. The client terminal as set forth in claim 19,
directly accessing the area or the data on said disk device through a network based on said determination information that was transmitted by said management server.

23. The client terminal as set forth in claim 19,
transmitting to said management server a notification of termination of said access and a notification of update of management information on the data on said disk device changed by said access.

24. A file sharing method whereby a plurality of client terminals shares data stored in at least one disk device through a networked management server, comprising the step of
transmitting with said management server to said client terminal, based on the data input/output request from said client terminal, determination information comprising positional information on the disk device targeted for input/output request disposed to be accessible by said client terminal through said network, and an area targeted for the input/output request on said disk device.

25. A file sharing method whereby a plurality of client terminals shares data stored in at least one disk device through a networked management server, comprising the step of
transmitting with said management server to said client terminal, based on the data input/output request from said client terminal, determination information comprising positional information on the disk device where said requested data is present and which is disposed to be accessible by said client terminal through said network, and on the data.
